(19) United States
(12) Patent Application Publication
(10) Pub. No.: US 2019/0219003 A1
(43) Pub. Date: Jul. 18, 2019

(54) Fuel Vapor Processing Apparatuses

(71) Applicant: AISAN KOGYO KABUSHIKI KAISHA, Obu-shi (JP)

(72) Inventor: Toshihiko YAMAUCHI, Kasugai-shi (JP)

(73) Assignee: AISAN KOGYO KABUSHIKI KAISHA, Obu-shi (JP)

(21) Appl. No.: 16/242,075

(22) Filed: Jan. 8, 2019

(30) Foreign Application Priority Data
Jan. 17, 2018 (JP) 2018-005420

(51) Int. Cl. F02M 25/08

(52) U.S. Cl. CPC F02M 25/0854; B01D 53/02

(57) ABSTRACT

A fuel vapor processing apparatus includes a plurality of adsorption layers disposed in a flow passage communicating a tank port with an atmosphere port and communicating a purge port with the atmosphere port. The plurality of adsorption layers include a first adsorption layer and a second adsorption layer that are arranged parallel to each other in a direction of gas through the flow passage and are disposed closest to the atmosphere port. A resistance against flow of gas through the first adsorption layer is less than a resistance against flow of gas through the second adsorption layer.

### CROSS-REFERENCE TO RELATED APPLICATIONS

This application claims benefit of Japanese patent application serial number 2018-005420 filed on Jan. 17, 2018, which is hereby incorporated herein by reference in its entirety.

### STATEMENT REGARDING FEDERALLY SPONSORED RESEARCH OR DEVELOPMENT

Not applicable.

### BACKGROUND

Embodiments of the present disclosure relate generally to fuel vapor processing apparatuses. More particularly, embodiments disclosed herein relate to fuel vapor processing apparatuses that may be mounted to vehicles, such as automobiles.

It is generally known to use fuel vapor processing apparatuses to temporarily adsorb fuel vapor produced in a fuel tank of a vehicle for inhibiting the fuel vapor from being dissipated into the atmosphere.

JP-A-2013-147987 (also published as US2013/0183207A1) discloses a fuel vapor processing apparatus that includes a tank port, a purge port, an atmosphere port, and a flow passage communicating between the tank port and the purge port, as well as between the tank port and the atmosphere port. A plurality of adsorption chambers are disposed in the flow passage. Each of the adsorption chambers are filled with adsorbent for adsorbing and desorbing fuel vapor contained in a fuel vapor containing gas that is a mixture of air and fuel vapor. One of the adsorption chambers located closest to the atmosphere port includes a large diameter portion and a projecting portion, each filled with the adsorbent. The adsorbent is filled into the large diameter portion over the entire cross sectional area of a flow passage portion defined by the large diameter portion. The projecting portion projects from the large diameter portion in a direction toward the atmosphere port. Because the cross sectional area of the projection portion is smaller than the cross sectional area of the large diameter portion, the resistance against flow of gas through the projection portion is larger than the resistance against flow of gas through the large diameter portion.

### SUMMARY

In one embodiment disclosed herein, a fuel vapor processing apparatus includes a tank port, a purge port, and an atmosphere port. A flow passage allows fluid communication between the tank port, the atmosphere port, and the purge port. A plurality of adsorption layers are disposed in the flow passage, and each adsorption layer contains adsorbent configured to adsorb and desorb fuel vapor. The plurality of adsorption layers include a first adsorption layer and a second adsorption layer arranged parallel to each other in a flow direction of the gas through the flow passage. The adsorption layers are disposed at a portion of the flow passage closest to the atmosphere port. The resistance against flow of gas through the first adsorption layer is smaller than the resistance against flow of gas through the second adsorption layer. The first adsorption layer and the second adsorption layer may be separated from each other by a partition wall so as to be parallel to each other in a flow direction of the gas therethrough. The partitioning wall prevents flow of gas between the first adsorption layer and the second adsorption layer through the partitioning wall.

Thus, the first adsorption layer with relatively small resistance against flow of gas and the second adsorption layer with relatively large resistance against flow of gas are arranged parallel to each other at the passage portion of the flow passage closest to the atmosphere port, while the first adsorption layer and the second adsorption layer are separated from each other by the partitioning wall.

Therefore, due to the difference in the flow resistance between the first adsorption layer and the second adsorption layer, a relatively large volume of the fuel vapor containing gas may flow through the first adsorption layer while a relatively small volume of the fuel vapor containing gas may flow through the second adsorption layer. Hence, it may be possible to inhibit degradation of the fuel vapor retaining capacity of the second adsorption layer having the relatively large flow resistance. As a result, an amount of breakthrough fuel vapor dissipated into the atmosphere via the atmosphere port may be reduced, for example, during a parking condition.

### BRIEF DESCRIPTION OF THE DRAWINGS

FIG. 1 is a cross-sectional view of an embodiment of a canister in accordance with principles disclosed herein; and

FIG. 2 is a bar graph illustrating a breakthrough amount of fuel vapor of a representative embodiment of a fuel vapor processing apparatus of the present disclosure in comparison with a conventional fuel vapor processing apparatus.

### DETAILED DESCRIPTION

In the fuel vapor processing apparatus disclosed in JP-A-2013-147987, the large diameter portion and the projecting portion communicate in series with each other in the flow direction of the gas. Therefore, if a large amount of the fuel vapor is adsorbed by the adsorbent contained in the large diameter portion and in the projecting portion, the fuel vapor retention capacities of both the large diameter portion and the projecting portion may be reduced. In such a case, it may be possible that some amount of the fuel vapor exceeding the retention capacity of the large diameter portion and/or the projecting portion may be blown out from the atmosphere port into the atmosphere during a normal condition of the vehicle (for example, during parking of the vehicle while a vehicle engine is stopped). Hence, the performance of the vehicle in a Diurnal Breathing Loss (DBL) test for fuel vapor dissipated into the atmosphere may be degraded.

Accordingly, there is a need in the art for a fuel vapor processing apparatus that can inhibit fuel vapor from dissipating from an atmospheric port into the atmosphere to reduce an amount of breakthrough fuel vapor. Embodiments of fuel vapor processing apparatuses disclosed herein offer the potential to inhibit fuel vapor from dissipating into the atmosphere, thereby reducing breakthrough of fuel vapor.

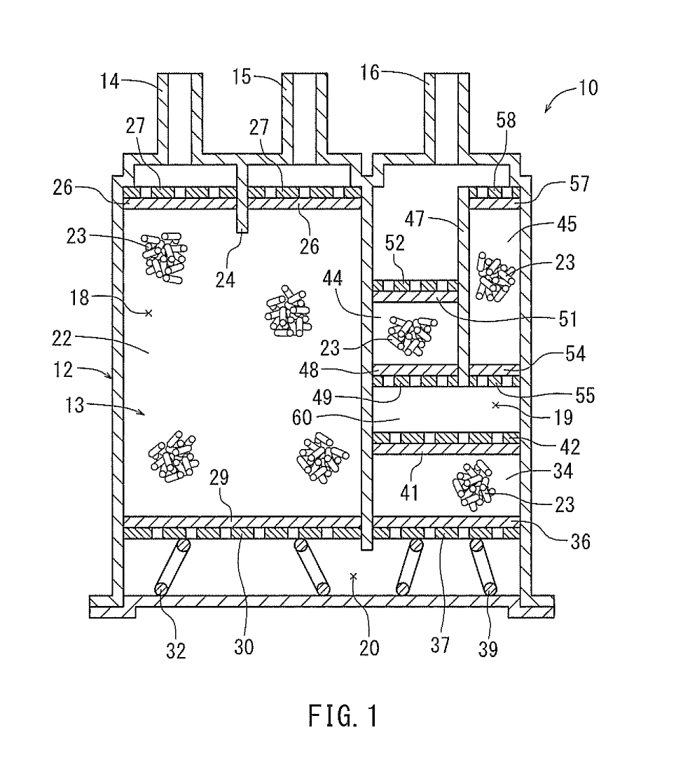

A representative embodiment will now be described with reference to FIG. 1.

Referring to FIG. 1, a canister 10 as an example of a fuel vapor processing apparatus is shown. The canister 10 may be mounted to a vehicle, such as an automobile, and may have a U-shaped flow passage structure. For the purpose of clarity and further explanation, the up-to-down direction, the left-to-right direction, and the front-to-rear direction of the canister 10 will be determined based on the orientation or the position of canister 10 shown in FIG. 1. However, this determination is not intended to limit the orientation or the position of the canister 10 relative to a vehicle to which the canister 10 is mounted.

As shown in FIG. 1, the canister 10 includes an outer case 12 having a generally U-shaped flow passage 13 formed therein for the flow of a fluid (the atmospheric air or a fuel vapor containing gas in this embodiment). A tank port 14 and a purge port 15 are formed on the case 12 at one end of the flow passage 13 (more specifically, an upstream end with respect to the flow of the fuel vapor containing gas). In addition, an atmosphere port 15 is formed on the case 12 at a position corresponding to the opposite end of the flow passage 13 (more specifically, a downstream end with respect to the flow of the fuel vapor containing gas). In general, the case 12 may be made of resin and may include a plurality of vertically separated case parts that are joined together by fusion-bonding with application of heat.

A main chamber 18 and an auxiliary chamber 19 are defined in the case 12. The upper end of the main chamber 18 is in fluid communication with the tank port 14 and the purge port 15. The upper end of the auxiliary chamber 19 is in fluid communication with the atmosphere port 16. The main chamber 18 and the auxiliary chamber 19 are separated from each other in the left-to-right direction but may be in series with each other with respect to the flow of the fluid via a communication chamber 20 that is formed within the lower end portion of the case 12. The fluid flows from the tank port 14 to the atmosphere port 16 via the main chamber 18, the communication chamber 20, and the auxiliary chamber 19 in this order, while the flow direction is reversed from the downward direction to the upward direction as the gas flows through the communication chamber 20.

The tank port 14 communicates with an upper gas space of a fuel tank (not shown) via a valve (not shown). The purge port 15 is connected to an intake passage of an engine (not shown) via a purge control valve (VSV) (not shown). An electronic control unit (ECU) (not shown) may control the opening of the purge control valve to perform a purge control during the driving operation of the engine.

A first adsorption layer 22 is disposed within the main chamber 18. The first adsorption layer 22 may include a plurality of adsorption granules 23 filled into the main chamber 18 with a predetermined filling ratio. As used herein, the term “filling ratio” for an adsorbent (i.e., adsorption granules) means “(the volume of space occupied by the adsorbent/the total volume of the corresponding adsorption layer)*100 (%).” The adsorption granules 23 may be activated carbon granules and can adsorb fuel vapor and allow desorption of fuel vapor. In this embodiment, activated carbon granules manufactured by a granulation process and having a predetermined average diameter may be used as the adsorption granules 23. Alternatively, activated carbon granules manufactured by a crushing process may be used as the adsorption granules 23.

Referring still to FIG. 1, a baffle plate 24 is disposed within the case 12 at a between the tank port 14 and the purge port 15 for dividing the upper end portion of the main chamber 18 into left-side and right-side portions. Therefore, the fluid may flow through the first adsorption layer 22 both in the case where the fluid flows into the tank port 14 and the case where the fluid flows out of the purge port 15.

A pair of left-side and right-side filters 26 are disposed at the upper surface part of the first adsorption layer 22 on the side of the tank port 14 and at the upper surface part of the first adsorption layer 22 on the side of the purge port 15, respectively, to cover these upper surfaces. For example, the filters 26 may be made of non-woven fabrics. A perforated plate 27 with a plurality of through-holes overlaps with the upper surface of each of the filters 26.

A filter 29 is disposed at the lower surface of the first adsorption layer 22 to cover the lower surface. For example, the filter 29 may be made of urethane foam. A perforated plate 30 with a plurality of through-holes overlaps with the lower surface of the filter 29. The perforated plate 30 may be biased upward by a biasing device 32 such as a coil spring.

A second adsorption layer 34 is disposed within a lower portion of the auxiliary chamber 19. Similar to the first adsorption layer 22, the second adsorption layer 34 may include adsorption granules (labeled with the same reference numeral as the adsorption granules 23, because they may be the same as the adsorption granules 23) filled into the auxiliary chamber 19 with a predetermined filling ratio. A filter 36 is disposed at the lower surface of the second adsorption layer 34 to cover the lower surface. Similar to the filter 29, the filter 36 may be made of urethane foam. A perforated plate 37 with a plurality of through-holes overlaps with the lower surface of the filter 36. The perforated plate 37 may be biased upward by a biasing device 39 such as a coil spring.

A filter 41 is disposed at the upper surface of the second adsorption layer 34 and may be made of urethane foam. A perforated plate 42 with a plurality of through-holes overlaps with the upper surface of the filter 41.

A third adsorption layer 44 and a fourth adsorption layer 45 are disposed within the upper portion of the auxiliary chamber 19 (along a flow passage portion closest to the atmosphere port 16). The third adsorption layer 44 and the fourth adsorption layer 45 are arranged parallel to each other with respect to the flow direction of the fluid. Similar to the first adsorption layer 22 and the second adsorption layer 34, each of the third adsorption layer 44 and the fourth adsorption layer 45 include adsorption granules (labeled with the same reference numeral as the adsorption granules 23 because they may be the same as the adsorption granules 23) filled with a predetermined filling ratio. The third adsorption layer 44 and the fourth adsorption layer 45 are separated from each other by a partitioning wall 47. Therefore, the third adsorption layer 44 and the fourth adsorption layer 45 cannot communicate with each other through the partitioning wall 47.

A filter 48 is disposed at the lower surface of the third adsorption layer 44 to cover the lower surface and may be made of urethane foam. A perforated plate 49 with a plurality of through-holes overlaps with the lower surface of the filter 48. A filter 51 is disposed at the upper surface of the third adsorption layer 44 to cover the upper surface and may be made of a non-woven fabric. A perforated plate 52 with a plurality of through-holes overlaps with the upper surface of the filter 51.

A filter 54 is disposed at the lower surface of the fourth adsorption layer 45 to cover the lower surface and may be made of urethane foam. A perforated plate 55 with a plurality of through-holes overlaps with the lower surface of the filter 54. A filter 57 is disposed at the upper surface of the fourth adsorption layer 45 to cover the upper surface and may be made of a non-woven fabric. A perforated plate 58 with a plurality of through-holes overlaps with the upper surface of the filter 57. In this embodiment, the lower surface of the fourth adsorption layer 45 is positioned at the same level as the lower surface of the third adsorption layer 44, while the upper surface of the fourth adsorption layer 45 is positioned at a higher level than the upper surface of the third adsorption layer 44.

A space 60 that does not contain adsorbent granules or any other adsorbent is positioned between the perforated plate 42 and the perforated plates 49 and 55 facing the perforated plate 42 in the vertical direction.

The length in the up-to-down direction of the third adsorption layer 44 (i.e., the length in the direction of flow of the fluid through the third adsorption layer 44) may be shorter than the length in the up-to-down direction of the fourth adsorption layer 45 (i.e., the length in the direction of flow of the fluid through the fourth adsorption layer 45). On the other hand, a passage cross sectional area of the third adsorption layer 44 is larger than a passage cross sectional area of the fourth adsorption layer 45. As used herein, the term “passage cross sectional area” refers to a cross sectional area of the adsorption layer 44 (45) in a direction perpendicular to the flow direction of the fluid through the corresponding adsorption layer. In this embodiment, the passage cross sectional area is a cross sectional area of the adsorption layer 44 (45) in the horizontal direction. Therefore, regarding an L/D ratio, where “L” denotes the length in the flow direction, and “D” denotes a diameter of a circle having the passage cross sectional area, the L/D ratio of the third adsorption layer 44 is less than the L/D ratio of the fourth adsorption layer 45. In other words, the third adsorption layer 44 has a relatively low L/D ratio, while the fourth adsorption layer 45 has a relatively high L/D ratio. The third adsorption layer 44 having the relatively low L/D ratio presents relatively low resistance against flow of the fluid, while the fourth adsorption layer 45 having the relatively high L/D ratio presents a relatively high resistance against flow of the fluid.

The operation of the canister 10 will now be described. Fuel vapor from gas in a fuel tank flows into the canister 10 via the tank port 14. After that, the fuel vapor flows through the first adsorption layer 22, the communication chamber 20, the second adsorption layer 34, and either the third adsorption layer 44 or the fourth adsorption layer 45 (in order), and is discharged to the atmosphere via the atmosphere port 16. More specifically, after leaving the second adsorption layer 34, the flow of the fuel vapor is divided into a first part that flows through third adsorption layer 44 and a second part that flows through the fourth adsorption layer 45. The first part and the second part then merge with each other before being discharged from the atmosphere port 16. The fuel vapor may be adsorbed by the adsorption granules 23 as it flows through the adsorption layers 22, 34, 44 or 45.

The fuel vapor adsorbed by the adsorption layers 22, 34, 44 and 45 can be desorbed and purged by a purge operation that may be performed during the driving operation of the engine. In order to perform the purge operation, the electronic control unit (ECU) outputs a signal to open the purge control valve, so that the atmospheric air may be introduced into the case 12 via the atmosphere port 16 by the negative pressure produced within the intake passage of the engine. The air introduced into the case 12 flows through the case 12 in a direction opposite to the flow of the fuel vapor during the adsorption process, so that fuel vapor adsorbed by the adsorption granules 23 of the adsorption layers 22, 34, 44 and 45 is desorbed by the flow of air. The air containing the desorbed fuel vapor may then be discharged from the purge port 15 to the intake passage of the engine.

According to the representative embodiment described above, the third adsorption layer 44 having the relatively small flow resistance and the fourth adsorption layer 45 having the relative large flow resistance are arranged parallel to each other with respect to the flow direction of the fuel vapor, while the third adsorption layer 44 and the fourth adsorption layer 45 are separated from each other by the partitioning wall 47, which prevents fluid flow between the third adsorption layer 44 and the fourth adsorption layer 45. Therefore, during the adsorption process of the fuel vapor, because of the difference in the flow resistance between the third adsorption layer 44 and the fourth adsorption layer 45, a relatively large volume of the fuel vapor flows through the third adsorption layer 44 having the relatively small flow resistance while a relatively small volume of the fuel vapor containing gas may flow through the fourth adsorption layer 45 having the relative large flow resistance. This offers the potential to inhibit degradation of the fuel vapor retaining capacity of the fourth adsorption layer 45. Hence, in the case that fuel vapor has been diffused within the space 60 during the normal condition of the vehicle (for example, during parking of the vehicle), the diffused fuel vapor may be effectively adsorbed by the fourth adsorption layer 45, which may still has a sufficient fuel vapor retaining capacity, thereby reducing an amount of breakthrough fuel vapor that dissipates into the atmosphere via the atmosphere port 16 during the normal condition.

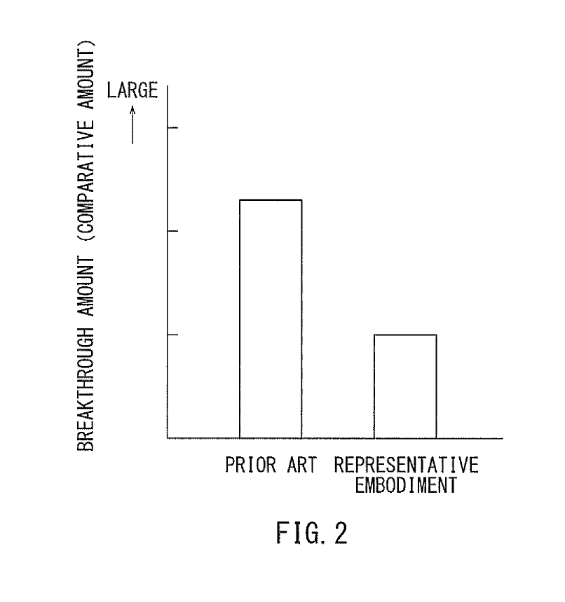

FIG. 2 illustrates a bar graph depicting comparative breakthrough amounts of fuel vapor from a representative embodiment of the present disclosure (e.g., canister 10) in comparison with a conventional fuel vapor processing apparatus. As shown in FIG. 2, the breakthrough amount of the representative embodiment is significantly reduced in comparison with that of the known art.

Embodiments described herein may be modified in various ways. For example, although the flow passage formed in the case 12 of the canister 10 is configured as a U-shaped flow passage, in other embodiments, the flow passage may be configured as an I-shaped flow passage or any other flow passage having a different shape from the U-shape. In addition, although the canister 10 has four adsorption layers 22, 34, 44 and 45, the canister 10 may have three or five or more adsorption layers. Further, although the same adsorption granules 23 are filled into the adsorption layers 22, 34, 44 and 45 with the same filling ratio in the above representative embodiment, the adsorption granules filled into the adsorption layers 22, 34, 44 and 45 may be different from each other. Still further, the same adsorption granules 23 or different adsorption granules may be filled into the adsorption layers 22, 34, 44 and 45 with different filling ratios from each other.

Representative, non-limiting examples were described above in detail with reference to the attached drawings. This detailed description is merely intended to teach a person of skill in the art further details for practicing preferred aspects of the present teachings and is not intended to limit the scope of the invention. Furthermore, each of the additional features and teachings disclosed above may be utilized separately or in conjunction with other features and teachings to provide improved fuel vapor processing apparatuses, and methods of making and using the same.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

What is claimed is:

1. A fuel vapor processing apparatus comprising:
a tank port;
a purge port;
an atmosphere port;
a flow passage configured to allow fluid communication between the tank port and the atmosphere port and configured to allow fluid communication between the purge port and the atmosphere port; and
a plurality of adsorption layers disposed in the flow passage, wherein each adsorption layer comprises adsorbent configured to adsorb and desorb fuel vapor, wherein:
the plurality of adsorption layers include a first adsorption layer and a second adsorption layer arranged parallel to each other in a direction of gas flow through the flow passage, wherein the first and second adsorption layers are disposed at a portion of the flow passage closest to the atmosphere port;
the first adsorption layer is configured to provide a resistance against flow of gas through the first adsorption layer and the second adsorption layer is configured to provide a resistance against flow of gas through the second adsorption layer that is smaller than the resistance against flow of gas through the first adsorption layer;
the first adsorption layer and the second adsorption layer are separated from each other by a partitioning wall configured to prevent flow of gas between the first adsorption layer and the second adsorption layer through the partitioning wall.

2. The fuel vapor processing apparatus according to claim 1, wherein:
the adsorbent contained in the second adsorption layer comprises the same material as the adsorbent contained in the first adsorbent; and
an L/D ratio of the first adsorption layer is greater than an L/D ratio of the second adsorption layer, wherein L is a length of the corresponding adsorption layer in the direction of flow of gas and D is a diameter of a circle having a same area as a cross sectional area of the corresponding adsorption layer in a direction perpendicular to the direction of flow of gas.

3. The fuel vapor processing apparatus according to claim 2, wherein:
the adsorbent of each of the first and second adsorption layers comprises a plurality of adsorption granules.

4. The fuel vapor processing apparatus according to claim 1, further comprising:
a pair of first filters positioned at opposite ends of the first adsorption layer relative to the direction of flow of gas through the first adsorption layer; and
a pair of second filters disposed at opposite ends of the second adsorption layer relative to the direction of flow of gas through the second adsorption layer.

5. The fuel vapor processing apparatus according to claim 4, further comprising:
a pair of first perforated plates, wherein each of the first perforated plates overlaps with one of the pair of first filters; and
a pair of second perforated plates, wherein each of the second perforated plates overlaps with one of the pair of second filters.

6. The fuel vapor processing apparatus according to claim 1, wherein:
the plurality of adsorption layers further comprises a third adsorption layer disposed on a side opposite to the atmosphere port with respect to the first and second adsorption chambers.

7. The fuel vapor processing apparatus according to claim 6, wherein:
the flow passage includes a first space containing no adsorbent, wherein the first space is positioned between the first adsorption layer and the third adsorption layer and positioned between the second adsorption layer and the third adsorption layer.

8. The fuel vapor processing apparatus according to claim 7, wherein:
the flow passage includes a second space containing no adsorbent, wherein the second space is positioned between the first adsorption layer and the atmosphere port and positioned between the second adsorption layer and the atmospheric port.

9. The fuel vapor processing apparatus according to claim 1, further comprising a case comprising the tank port, the purge port, and the atmosphere port, wherein:
the flow passage extends through the case; and
the partitioning wall is formed within the case.

10. A fuel vapor processing apparatus comprising:
a tank port;
a purge port;
an atmosphere port;
a flow passage extending from the tank port and the purge port to the atmosphere port;
a first adsorbent layer disposed in the flow passage and a second adsorbent layer disposed in the flow passage, wherein each adsorbent layer comprises an adsorbent configured to adsorb and desorb fuel vapor, wherein:
the first adsorption layer and the second adsorption layer are arranged parallel to each other in the direction of flow of gas through the flow passage; and
an L/D ratio of the first adsorption layer is greater than an L/D ratio of the second adsorption layer, where L is a length of the corresponding adsorption layer and D is a diameter of a circle having a same area as a cross sectional area of the corresponding adsorption layer in a direction perpendicular to the direction of flow of gas.

11. The fuel vapor processing apparatus according to claim 10, wherein:
no adsorption layer is positioned between the first adsorption layer and the atmosphere port and no adsorption layer is positioned between the second adsorption layer and the atmosphere port.

12. A fuel vapor processing apparatus comprising:
a tank port;
a purge port;
an atmosphere port;
a flow passage configured to provide fluid communication between the tank port and the atmosphere port and configured to provide fluid communication between the purge port and the atmosphere port;
a first adsorbent layer and a second adsorbent layer disposed in the flow passage, wherein each adsorbent layer contains an adsorbent configured to adsorb and desorb fuel vapor, wherein:
the first adsorption layer and the second adsorption layer are arranged parallel to each other in the direction of flow of gas through the flow passage;
the adsorbent of the first adsorption layer is filled into the first adsorption layer with a first filling ratio; and
the adsorbent of the second adsorption layer is filled into the second adsorption layer with a second filling ratio that is different from the first filling ratio.

13. The fuel vapor processing apparatus according to claim 12, wherein:
no adsorption layer is disposed between the first adsorption layer and the atmosphere port and no adsorption layer is disposed between the second adsorption layer and the atmosphere port.
